(19) United States
(12) Patent Application Publication
(10) Pub. No.: US 2010/0302523 A1
(43) Pub. Date: Dec. 2, 2010

(54) METHOD AND APPARATUS FOR MEASURING WAVEFRONT, AND EXPOSURE METHOD AND APPARATUS

(75) Inventor: Naomasa SHIRAISHI, Saitama-shi (JP)

Correspondence Address: OLIFF & BERRIDGE, PLC, P.O. BOX 320850, ALEXANDRIA, VA, 22320-4850, US

(73) Assignee: NIKON CORPORATION, Tokyo (JP)

(21) Appl. No.: 12/781,117

(22) Filed: May 17, 2010

Related U.S. Application Data
(60) Provisional application No. 61/213,219, filed on May 18, 2009.

(51) Int. Cl. G03B 27/54; G01B 11/02

(52) U.S. Cl. 355/67; 356/515

(57) ABSTRACT

A method for measuring wavefront information of a projection optical system includes arranging a first diffraction grating having a pitch P1 on a side of an object plane of the projection optical system; arranging a second diffraction grating having a pitch P2 which is ½ of a pitch of an image of the first diffraction grating formed by the projection optical system, on a side of an image plane of the projection optical system PL; illuminating the first diffraction grating with an illumination light; receiving interference fringes of a shearing interference light composed of two pairs of diffracted lights formed by the illumination light from the second diffraction grating via the first diffraction grating and the projection optical system; and determining the wavefront information of the projection optical system based on the received interference fringes. The wavefront information of the projection optical system can be measured highly accurately.

### CROSS-REFERENCE TO RELATED APPLICATION

This application claims the benefit of priority of U.S. Provisional Application Ser. No. 61/213,219 filed on May 18, 2009, and the disclosure of U.S. Provisional Application Ser. No. 61/213,219 is incorporated herein by reference in its entirety.

### BACKGROUND OF THE INVENTION

1. Field of the Invention

The present invention relates to a measuring technique for measuring wavefront information of a projection optical system, and an exposure technique using the measuring technique.

2. Description of the Related Art

For example, in a photolithography step for producing a microdevice (electronic device) such as a semiconductor device or the like, an exposure apparatus is used to transfer a pattern of a reticle or the like onto a wafer (or a glass plate, etc.), on which a photoresist is coated, via a projection optical system to perform the exposure. In order that the imaging characteristic including the aberration of the projection optical system, etc., is maintained to be in a predetermined state in the exposure apparatus, it is necessary to correctly measure the imaging characteristic of the projection optical system. In view of the above, for example, measuring apparatuses have been suggested, which perform the on-body measurement for the wavefront aberration (wave aberration) of the projection optical system.

Apparatuses which adopt, for example, the shearing method and the PDI (Point Diffraction Interferometer) method are known as the conventional measuring apparatuses (see, for example, U.S. Pat. No. 6,573,997). An apparatus, which adopts the Shack-Hartmann method, is also known (see, for example, Japanese Patent Application Laid-open No. 2002-250677). In any one of these apparatuses, a minute (micro) aperture (transmission) pattern, which is approximately at an extent of the resolution limit of a projection optical system, is arranged on a side of the object plane (object plane side) of the projection optical system. A light (light beam), which is transmitted through the aperture pattern and which is collected or condensed by the projection optical system, is subjected to interference or imaging (image formation) in accordance with a predetermined method on a side of the image plane (image plane side) of the projection optical system. The aberration of the projection optical system is measured based on interference fringes or position information of the image.

A double diffraction grating type shearing method, which is provided by improving the shearing method, has been also suggested (see, for example, Japanese Patent Application Laid-open No. 2008-263232). In this case, a first diffraction grating is arranged on the object plane side of a projection optical system, and a second diffraction grating, which has a pitch that is twice the pitch of the image of the first diffraction grating, is arranged on the image plane side of the projection optical system to measure the light intensity distributions of interference fringes of a plurality of pairs of diffracted lights (diffracted light beams) having different orders obtained via the first diffraction grating, the projection optical system, and the second diffraction grating. The wavefront aberration of the projection optical system is determined from the measurement result.

In the conventional apparatuses which adopt the shearing method, the PDI method and the Shack-Hartmann method, the amount of light, which is used to measure the wavefront information, is restricted by the minute aperture arranged on the object plane side of the projection optical system, and the light amount of the interference fringes or the image is lowered. Therefore, the following problem arises. That is, it is necessary to increase the measuring time in order to secure a sufficient light amount and to measure the wavefront information highly accurately; and that it is difficult to perform the measurement at a high speed.

In the wavefront aberration measuring apparatus of the double diffraction grating type shearing interference system, the ratio is inappropriate between the pitch of the first diffraction grating which is arranged on the object plane side of the projection optical system and the pitch of the second diffraction grating which is arranged on the image plane side. Therefore, the interference components, which are brought about by the higher order diffracted lights generated from the second diffraction grating, tend to be mixed into the interference fringes on a light-receiving surface. Further, since the higher order diffracted lights act as the noise light, a problem arises such that the measurement accuracy is lowered or deteriorated for the wavefront aberration.

### SUMMARY OF THE INVENTION

Taking the foregoing circumstances into consideration, an object of an aspect of the present invention is to provide a wavefront measuring method which makes it possible to highly accurately measure the wavefront information including, for example, the wavefront aberration of a projection optical system, an exposure method including the same, a wavefront measuring apparatus, and an exposure apparatus including the same.

According to a first aspect, there is provided a wavefront measuring method for measuring wavefront information of a projection optical system, the wavefront measuring method comprising arranging a first grating on a side of an object plane of the projection optical system; arranging a second grating, having a pitch which is ½ of a pitch of an image of the first grating, on a side of an image plane of the projection optical system; illuminating the first grating with an illumination light; receiving interference fringes formed by the illumination light from the second grating via the first grating and the projection optical system; and determining the wavefront information of the projection optical system based on the received interference fringes.

According to a second aspect, there is provided an exposure method for illuminating a pattern with an illumination light and exposing an object with the illumination light via the pattern and a projection optical system, the exposure method comprising determining wavefront information of the projection optical system by using the wavefront measuring method in accordance with the first aspect; adjusting the projection optical system based on the determined wavefront information of the projection optical system; and illuminating the object with the illumination light via the pattern and the adjusted projection optical system.

According to a third aspect, there is provided a wavefront measuring apparatus which measures wavefront information of a projection optical system, the wavefront measuring apparatus comprising a first grating arranged on a side of an object plane of the projection optical system; a second grating arranged on a side of an image plane of the projection optical system and having a pitch which is ½ of a pitch of an image of the first grating; an illumination system which illuminates the first grating with an illumination light; a photoelectric sensor which detects an intensity distribution of interference fringes formed by the illumination light from the second grating via the first grating and the projection optical system; and an arithmetic section (arithmetic device) which determines the wavefront information of the projection optical system based on a detection result of the photoelectric sensor.

According to a fourth aspect, there is provided an exposure apparatus which illuminates a pattern with an illumination light and exposes an object with the illumination light via the pattern, the exposure apparatus comprising a projection optical system which projects, onto the object, an image of the pattern illuminated with the illumination light; and the wavefront measuring apparatus in accordance with the third aspect which is used to determine the wavefront information of the projection optical system; wherein the pattern is illuminated by using the illumination system of the wavefront measuring apparatus. According to a fifth aspect, there is provided a device producing method comprising exposing a substrate by using the exposure method or the exposure apparatus of the present invention; and processing the exposed substrate.

### BRIEF DESCRIPTION OF THE DRAWINGS

FIG. 1 shows a perspective view of an exposure apparatus which is used in an exemplary embodiment.

FIG. 2 shows a sectional view of optical paths for a large number of diffracted lights generated during the measurement of the wavefront aberration of a projection optical system by using a wavefront measuring unit 30Y shown in FIG. 1.

FIG. 3A shows optical paths for the 0 order light and the interference light (interference light beam) composed of two pairs of diffracted lights shown in FIG. 2; FIG. 3B shows the ±1 order diffracted light on the pupil plane of a projection optical system PL shown in FIG. 3A; FIG. 3C shows a contour of interference fringes on a light-receiving surface of an image pickup element shown in FIG. 3A; FIG. 3D shows a part of the phase distribution of the +1 order diffracted light; FIG. 3E shows a part of the phase distribution of the −1 order diffracted light; and FIG. 3F shows a part of the phase distribution of the interference fringes.

FIG. 4 (FIGS. 4A, 4B) shows a flow chart illustrating an example of operation for measuring the wavefront aberration of the projection optical system.

FIG. 5 shows an example of a one-dimensional numerical filter NF appropriate for the single image forming process.

FIG. 6 shows a sectional view of a state that the wavefront aberration of a projection optical system is measured by using a wavefront measuring unit 30AY in a second embodiment.

FIG. 7 shows a flow chart illustrating an example of steps of producing an electronic device.

FIG. 8 shows optical paths for a large number of diffracted lights of Comparative Example as compared with the embodiment.

### DESCRIPTION OF THE PREFERRED EMBODIMENTS

### First Embodiment

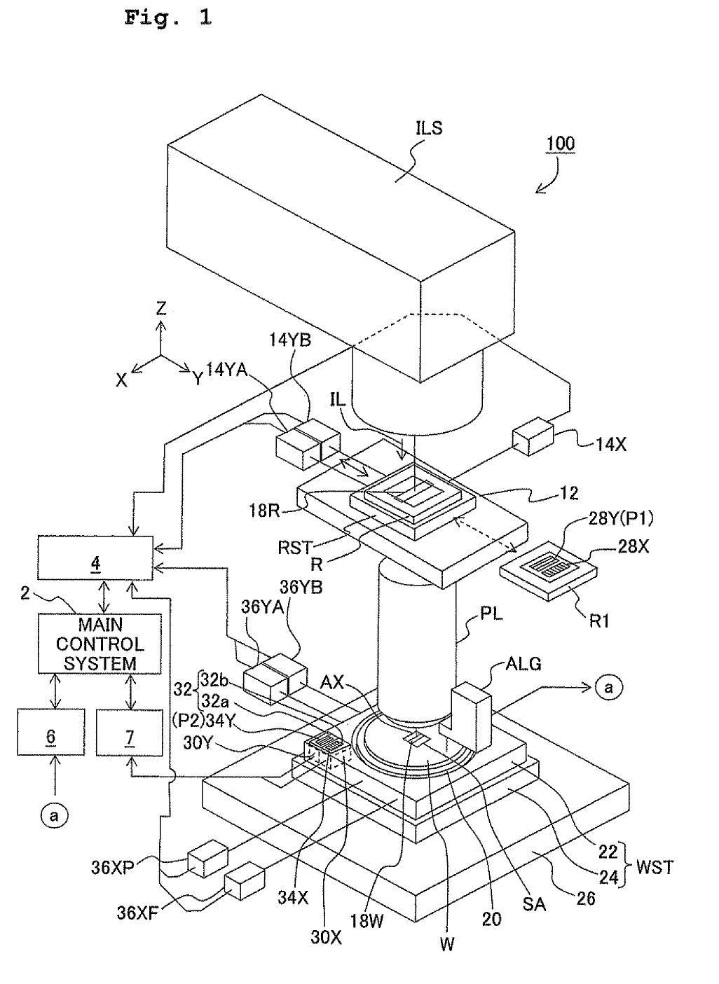

A first embodiment of the present invention will be explained below with reference to FIGS. 1 to 5.

FIG. 1 shows a schematic construction of a scanning exposure type exposure apparatus 100 constructed of a scanning stepper according to this embodiment. With reference to FIG. 1, the exposure apparatus 100 includes an exposure light source (not shown); and an illumination optical system ILS which illuminates a pattern surface (lower surface in this embodiment) of a reticle R (mask) in an illumination area 18R with an illumination light (illumination light beam or exposure light, exposure light beam) IL for exposure from the exposure light source. The exposure apparatus 100 further includes a reticle stage RST which moves the reticle R; a projection optical system PL which forms an image of the pattern in the illumination area 18R of the reticle R on an exposure area 18W on a surface of a wafer W (substrate) under the illumination light IL; a wafer stage WST which positions and moves the wafer W; a main control system 2 constructed of a computer which integrally controls the operation of the entire apparatus; other driving systems; and the like.

The following explanation will be made assuming that the Z axis extends in parallel to an optical axis AX of the projection optical system PL, the X axis and the Y axis extend in two perpendicular directions in a plane (substantially parallel to the horizontal plane in this embodiment) perpendicular to the Z axis, and directions of rotation (inclination) about the axes parallel to the X axis, the Y axis, and the Z axis are designated as θx, θy, and θz directions respectively. In this embodiment, a direction (Y direction), which is parallel to the Y axis, is the scanning direction for the reticle R and the wafer W during the scanning exposure.

An ArF excimer laser (wavelength: 193 nm) is used as the exposure light source described above. Other than the above, those usable as the exposure light source also include an ultraviolet pulsed laser light source such as the KrF excimer laser (wavelength: 248 nm) or the like; a high harmonic wave generating light source of the YAG laser; a high harmonic wave generator of the solid-state laser (semiconductor laser or the like); a the discharge lamp such as the mercury lamp or the like; and the like.

The illumination optical system ILS includes, for example, an illuminance uniformizing optical system including an optical integrator (for example, an fly's eye lens, a rod integrator, a diffraction optical element or the like), fixed and variable reticle blinds (fixed and variable field stops (field diaphragms)), a condenser optical system, etc., as disclosed, for example, in United States Patent Application Publication No. 2003/0025890. The illumination optical system ILS illuminates the illumination area 18R which is disposed on the pattern area of the reticle R and which is defined and opened/closed by the reticle blinds, with the illumination light IL at a substantially uniform illuminance distribution. The illumination area 18R is, as an example, a rectangle which is elongated or long in the X direction (non-scanning direction). The intensity distribution of the illumination light IL, which is provided on the pupil plane (plane conjugate with the light-exit pupil) in the illumination optical system ILS, is switched by an unillustrated setting mechanism into a circular area with the optical axis as the center, two or four partial areas which are eccentric from the optical axis, an annular or zonal area with the optical axis as the center, etc., depending on the illumination condition including the ordinary illumination, the dipole or quadruple illumination, the annular or zonal illumination, etc.

The pattern (circuit pattern), which is disposed in the illumination area 18R of the reticle R, is projected onto the exposure area 18W (area conjugate with the illumination area 18R) disposed on one shot area SA of the wafer W at a predetermined projection magnification β (for example, a reduction magnification of ¼, ⅕ or the like) via the projection optical system PL which is telecentric on the both sides (or on one side of the side of the wafer W) under the illumination light IL. During the ordinary exposure, the pattern surface of the reticle R is arranged on the object plane of the projection optical system PL, and the surface (exposure surface) of the wafer W is arranged on the image plane of the projection optical system PL. The projection optical system PL is the refractive or dioptric system. However, other than the above, it is also possible to use a catadioptric system, etc. The wafer W (substrate) is provided, for example, by coating a photoresist (photosensitive material) on a disk-shaped base member which is composed of silicon and which has a diameter of 200 mm or 300 mm, etc.

With reference to FIG. 1, the reticle R is attracted and held on the reticle stage RST via a reticle holder (not shown). The reticle stage RST is placed on an upper surface of a reticle base 12 parallel to the XY plane via an air bearing. The reticle stage RST is movable at a constant velocity in the Y direction on the reticle base 12, and it is possible to finely adjust the positions in the X direction and the Y direction and the angle of rotation in the θz direction. The two-dimensional position information, which includes at least the positions in the X direction and the Y direction and the angle of rotation in the θz direction of the reticle stage RST, is measured by a reticle side interferometer system which includes, for example, a laser interferometer 14X for the X axis and two-axis laser interferometers 14YA, 14YB for the Y axis. The measurement result is supplied to a stage driving system 4 and the main control system 2. The stage driving system 4 controls the position, the velocity, and the angle of rotation of the reticle stage RST via an unillustrated driving mechanism (a linear motor, etc.) based on the position information and a control information from the main control system 2.

On the other hand, the wafer W is held on the wafer stage WST. The wafer stage WST is provided with an XY stage 24 which is movable in the X direction and the Y direction via an air bearing on an upper surface of a wafer base 26 parallel to the XY plane, and a Z tilt stage 22 which attracts and holds the wafer W via a wafer holder 20. The Z tilt stage 22 controls a position (focus position) in the optical axis AX direction and angles of rotation in the θx and θy directions of an upper portion (wafer W) of the Z tilt stage 22, so that the surface (or any other surface) of the wafer W is focused with respect to the image plane of the projection optical system PL, based on a measured value of a multi-point autofocus sensor of the oblique incidence system (not shown) constructed in the same manner as that disclosed, for example, in U.S. Pat. No. 5,448,332, etc.

The two-dimensional position information of the wafer stage WST, which includes at least the positions in the X direction and the Y direction and the angle of rotation in the θz direction of the Z tilt stage 22 (wafer W), is measured by a wafer side interferometer system including, for example, two-axis laser interferometers 36XP, 36XF for the X axis and two-axis laser interferometers 36YA, 36YB for the Y axis. The measurement result is supplied to the stage driving system 4 and the main control system 2. The stage driving system 4 controls the two-dimensional position of the wafer stage WST (XY stage 24) via an unillustrated driving mechanism (a linear motor, etc.) based on the position information and a control information from the main control system 2.

The measurement result of a wafer alignment system ALG which is arranged on a side surface in the +Y direction of the projection optical system PL and which is of the off-axis system and for example of the image processing system, and the measurement result of the position of an alignment mark (not shown) of the reticle R which is measured by a reticle alignment system (not shown) are supplied to an alignment control system 6. The alignment control system 6 performs the alignment for the reticle R and the wafer W based on the measurement results. A reference member (not shown), which is formed with a reference mark for determining the positional relationship (baseline) between the image of the pattern of the reticle R and the detection center of the wafer alignment system ALG, is also fixed in the vicinity of the wafer W on the Z tilt stage 22.

In order to measure the wavefront aberration of the projection optical system PL, a Y axis wavefront measuring unit 30Y and an X axis wavefront measuring unit 30X are provided on the Z tilt stage 22. A glass plate 32 (32a, 32b), which has an upper surface arranged at a same height as that of the image plane of the projection optical system PL and through which the illumination light IL is transmitted, is fixed at upper portions of the wavefront measuring units 30Y, 30X. A Y direction-diffraction grating 34Y, in which a line pattern of a light shielding film (light shielding portion) and a light transmitting portion are alternately arranged at a predetermined pitch P2 in the Y direction, is formed on the upper surface of a glass plate 32a of the wavefront measuring unit 30Y. Further, an X direction-diffraction grating 34X, in which a line pattern of a light shielding film (light shielding portion) and a light transmitting portion are alternately arranged at the pitch P2 (the same pitch as that of the Y direction-diffraction grating 34Y) in the X direction, is formed on the upper surface of a glass plate 32b of the wavefront measuring unit 30X.

It is allowable that each of the diffraction gratings 34X, 34Y has a shape smaller than the exposure area 18W. Each of the diffraction gratings 34X, 34Y may also have a size which is, for example, not less than 100 μm square and which is sufficiently large as compared with the resolution limit (about 0.1 μm) of the projection optical system PL.

The wavefront measuring unit 30Y measures information of the intensity distribution (light intensity distribution) of the interference fringes (Y axis shearing wavefront) formed by a plurality of diffracted lights exiting from the diffraction grating 34Y as described later on; and the wavefront measuring unit 30Y supplies the measurement result to a wavefront information arithmetic section (calculating section) 7. Similarly, the wavefront measuring unit 30X measures information of the intensity distribution of the interference fringes (X axis shearing wavefront) formed by a plurality of diffracted lights exiting from the diffraction grating 34X; and the wavefront measuring unit 30X supplies the measurement result to the wavefront information arithmetic section 7. The wavefront information arithmetic section 7 determines the wavefront aberration of the projection optical system PL by using the information about the intensity distributions (details will be described later on); and the wavefront information arithmetic section 7 supplies the measured wavefront aberration to the main control system 2.

An imaging characteristic correcting mechanism (not shown) is also provided which is similar to that disclosed, for example, in United States Patent Application Publication No. 2006/244940, and which corrects the imaging characteristic, which includes the distortion, the magnification error, the coma aberration (wavefront aberration), etc. of the projection optical system PL, by controlling the positions in the Z direction and the angles of inclination in the θx and θy directions of a plurality of predetermined lenses constructing the projection optical system PL. In this case, the relationship between the fluctuation (variation) amount of the imaging characteristic and the totalized radiation amount of the illumination light IL which comes into the projection optical system PL is previously determined; and the imaging characteristic correcting mechanism is driven so that the fluctuation amount of the imaging characteristic is suppressed based on the relationship. For example, the wavefront aberration which remains when the imaging characteristic correcting mechanism is driven is measured by using, for example, the wavefront measuring unit 30Y described above. The driving amount of the imaging characteristic correcting mechanism is corrected based on the measurement result.

During the exposure, one shot area SA on the wafer W is exposed with an image of the pattern (pattern image) in the illumination area 18R of the reticle R as formed by the projection optical system PL, while the reticle R and the wafer W are synchronously moved in the Y direction at a velocity ratio of the projection magnification β. By doing so, the concerning shot area SA is subjected to the scanning exposure with the image of the pattern of the reticle R. After that, the operation in which the wafer stage WST is driven to step-move the wafer W in the X direction and the Y direction and the scanning exposure operation are repeated. Thus, the respective shot areas, which are disposed on the wafer W, are exposed with the pattern image of the reticle R in the step-and-scan manner.

Next, an explanation will be made about the construction of a measuring apparatus measuring the wavefront aberration of the projection optical system PL. The Y axis wavefront measuring unit 30Y and the X axis wavefront measuring unit 30X are different from each other only in that the shearing directions of the wavefronts are perpendicular to each other, but are basically constructed identically. Therefore, the following description will be principally made about a measuring apparatus which uses the Y axis wavefront measuring unit 30Y. At first, when the wavefront aberration of the projection optical system PL is measured, the reticle R on the reticle stage RST is exchanged with a test reticle R1 by an unillustrated reticle loader system. A pattern area of the test reticle R1 is formed with a Y direction-diffraction grating 28Y in which a line pattern (elongated light shielding area extending in the Y direction) of a light shielding film (light shielding portion) and a transmitting portion (elongated transmitting area extending in the Y direction) are alternately arranged at a predetermined pitch P1 in the Y direction and an X direction-diffraction grating 28X in which a line pattern (elongated light shielding area extending in the X direction) of a light shielding film (light shielding portion) and a transmitting portion (elongated transmitting area extending in the X direction) are alternately arranged at the same pitch P1 in the X direction, in a state that the alignment is completed. It is allowable that each of the diffraction gratings 28X, 28Y has a shape smaller than the illumination area 18R. In a case that the wavefront measuring unit 30Y is used, the diffraction grating 28Y is arranged at the measuring position in the illumination area 18R; in a case that the wavefront measuring unit 30X is used, the diffraction grating 28X is used.

It is desirable that each of the diffraction gratings 28X, 28Y has a size which is large to an extent of reciprocal (inverse number) times the size of each of the diffraction gratings 34X, 34Y, the reciprocal (inverse number) being of the projection magnification β of the projection optical system. Therefore, for example, it is assumed that each of the diffraction gratings 34X, 34Y has a size of 100 μm square and the magnification of the projection optical system is ¼-fold. On this assumption, it is desirable that the size of each of the diffraction gratings 28X, 28Y is a size of about 400 μm square.

That is, in this embodiment and another embodiment described later on, unlike any conventional apparatus which adopts the shearing method, the PDI method, or the Shack-Hartmann method, it is unnecessary to provide any minute (micro) aperture which is in an extent of the resolution limit and which is disposed on the object plane side of the projection optical system. Therefore, there is also no light amount loss which would be caused by the minute aperture. Consequently, a large light amount can be obtained on an image pickup element 38 as described later on; and it is thus possible to measure the wavefront information highly accurately at a high speed.

The diffraction gratings 28Y, 28X may be formed, for example, at a part or portion of an evaluating substrate (not shown) fixed at a position adjacent to the reticle on the reticle stage RST in the scanning direction.

Only any one of the wavefront measuring unit 30X and the wavefront measuring unit 30Y can be used to measure the aberration of the projection optical system at high performance. Therefore, for example, in a case that the installation space is restricted, it is sufficient that any one of the wavefront measuring units is provided.

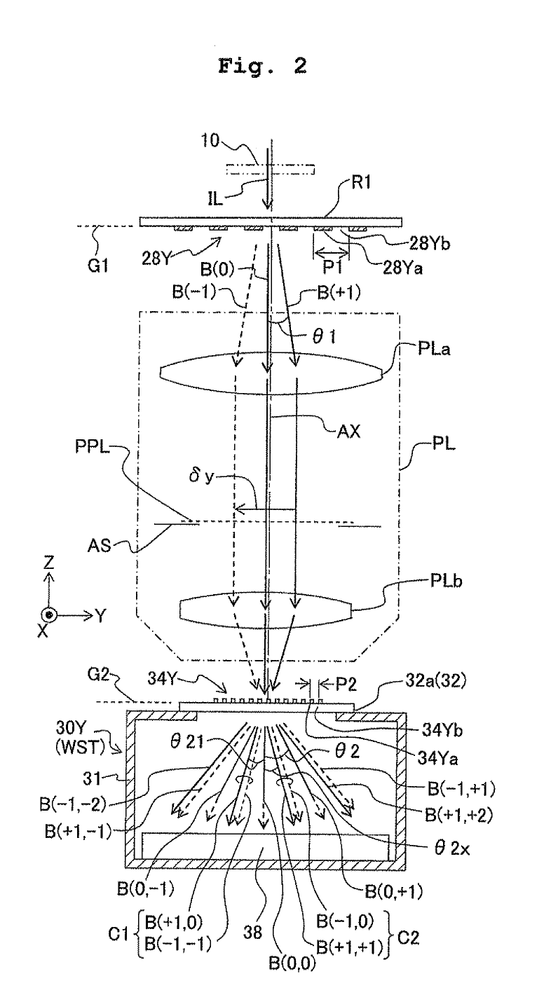

FIG. 2 shows a state that the wavefront aberration of the projection optical system PL is measured by using the wavefront measuring unit 30Y. For the purpose of convenience of the explanation in the following description, the projection optical system PL is represented by an optical system including a front group lens system PLa, a rear group lens system PLb, and an aperture stop (aperture diaphragm) AS arranged on a pupil plane PPL between the front group lens system PLa and the rear group lens system PLb. However, the projection optical system PL may be constructed arbitrarily. In FIG. 2, etc., the diffraction grating 28Y and other components are depicted while magnifying the pitch thereof as compared with the actual pitch.

With reference to FIG. 2, the diffraction grating 28Y, which has the pitch (period) P1 in the Y direction and which is formed on the pattern surface of the test reticle R1, is arranged on an object plane G1 of the projection optical system PL in the illumination area 18R shown in FIG. 1. The illumination optical system ILS shown in FIG. 1, which illuminates the diffraction grating 28Y, is set to provide the ordinary illumination. The coherence factor (=numerical aperture of illumination light IL/numerical aperture NAin on object plane side of projection optical system PL=σ value) of the illumination light IL irradiated or radiated onto the diffraction grating 28Y is set, as an example, within the following range.

σ value=0.8 to 1 (1)

Accordingly, the diffracted light, which is generated from the diffraction grating 28Y, is spread over the substantially entire surface (80 to 100%) on the pupil plane PPL of the projection optical system PL. In order to increase the σ value of the illumination light IL which exits from the illumination optical system ILS, a diffusion plate 10 may be disposed over or above the test reticle R1 as depicted by broken lines.

In this case, the following relationship holds between the numerical aperture NAin on the object plane side of the projection optical system PL and the numerical aperture NA on the image plane side of the projection optical system PL by using the projection magnification β (for example, β=¼, ⅕ or the like) from the object plane to the image plane of the projection optical system PL. The numerical aperture NA of the projection optical system PL is, for example, about 0.8 to 0.9.

NAin=β×NA (2)

Assuming that λ represents the wavelength of the illumination light IL, it is preferable that the pitch P1 of the diffraction grating 28Y is set within the following range.

4×λ/NAin≦P1≦200×λ/NAin (3A)

In this embodiment, the wavelength λ is 193 nm. Therefore, as an example, assuming that the projection magnification β is ¼ and the numerical aperture NA is 0.85, the pitch P1 is about 3.6 to 182 μm according to the expression (3A).

In FIG. 2, the illumination light IL and the diffracted lights are represented by the main lights (main light beams) thereof. The illumination light IL is radiated onto the diffraction grating 28Y along with the optical axis AX. The 0 order light B(0), the +1 order diffracted light B(+1), the −1 order diffracted light B(−1), and the diffracted lights of the 2nd order or higher orders (not shown) exit from the diffraction grating 28Y to the projection optical system PL.

The angle of diffraction θ1 of the +1 order diffracted light B(+1) is defined by sin θ1=λ/P1, and the angle of diffraction of the −1 order diffracted light B(−1) is −θ1. In this embodiment, the spacing distance in the Y direction between the main lights of the diffracted light B(+1) and the diffracted light B(−1) on the pupil plane PPL of the projection optical system PL is the shear amount (positional deviation amount) δy for the two wavefronts subjected to the shearing interference. The shear amount δy is as follows by using the unit of the numerical aperture NAin of the projection optical system PL.

δy=2·sin θ1=2·λ/P1 (4)

The following relationship is obtained by substituting the expression (3A) with the expression (4).

NAin/100≦δy≦NAin/2 (3B)

That is, in a case that the expression (3A) holds, the shear amount δy for the two wavefronts on the pupil plane PPL is within a range of 1/100 to ½ of the numerical aperture NAin (corresponding to the radius of the aperture of the aperture stop AS) according to the expression (3B). If the shear amount δy is smaller than the lower limit of the expression (3B), the influence, which is exerted by the measuring noise on the measurement accuracy of the wavefront aberration, is increased, because the shear amount is small. On the other hand, if the shear amount δy is larger than the upper limit of the expression (3B), the accuracy of the determined wavefront aberration, especially the measurement accuracy of the higher order wavefront aberration is not sufficient.

It is more preferable that the pitch P1 of the diffraction grating 28Y is within the following range.

8×λ/NAin≦P1≦100×λ/NAin (5A)

In this case, the shear amount δy hardly suffers from the influence of the noise as follows, and the range is preferred in view of the accuracy as well.

NAin/50≦δy≦NAin/4 (5B)

The area, which is irradiated with the illumination light IL on the diffraction grating 28Y, may be converged into a predetermined narrow range by a blind included in the illumination optical system ILS shown in FIG. 1.

Subsequently, with reference to FIG. 2, the diffraction grating 34Y, which has the pitch (period) P2 in the Y direction of the upper surface of the glass plate 32a of the wavefront measuring unit 30Y, is arranged on an image plane G2 of the projection optical system PL so that at least a part of the diffraction grating 34Y is overlapped or overlaid with the position of the image of the diffraction grating 28Y brought about by the projection optical system PL. Further, a two-dimensional image pickup element 38 of, for example, the CCD or CMOS type is arranged, which has a light-receiving surface in an area irradiated with the large number of diffracted lights (including the 0 order light) generated from the diffraction grating 34Y. The detection signal of the image pickup element 38 is supplied to the wavefront information arithmetic section 7 shown in FIG. 1. The wavefront measuring unit 30Y is constructed to include the glass plate 32a (diffraction grating 34Y), the image pickup element 38, and a casing 31 which supports these components or parts. The wavefront measuring unit 30Y is fixed to an upper portion of the wafer stage WST (Z tilt stage 22). In this case, the pitch P2 of the diffraction grating 34Y is set to be ½ of the pitch of the image of the diffraction grating 28Y formed by the projection optical system PL. Therefore, the following expression is given by using the projection magnification β of the projection optical system PL.

P2=β×P1/2 (6)

In a case that the range of the pitch P1 of the diffraction grating 28Y resides in the expression (3A), as an example, it is assumed that the projection magnification β is ¼ and the numerical aperture NA is 0.85. On this assumption, according to the expression (6), the pitch P2 of the diffraction grating 34Y is about 0.45 to 23 μm.

It is preferable for the diffraction grating 34Y that the ratio (duty ratio) between a width D2Ya of a light shielding portion 34Ya in the periodic direction and a width D2Yb of a transmitting portion 34Yb is 1:1 as follows. In this case, any even number order diffracted light, which includes, for example, the 2 order and 4 order diffracted lights, is not generated from the diffraction grating 34Y. Practically, it is enough that the ratio of the even number order diffracted lights is merely decreased. Therefore, it is also allowable that the following expression (7) merely holds approximately.

D2Ya:D2Yb=1:1 (7)

The 0 order light B(0) and the ±1 order diffracted lights B(+1), B(−1), which are generated from the diffraction grating 28Y on the object plane G1, come into the diffraction grating 34Y on the image plane G2 via the projection optical system PL. Those exiting from the diffraction grating 34Y are the 0 order light B(0,0) and the ±1 order diffracted lights B(0,+1), B(0,−1) of the incident 0 order light B(0); the 0 order light B(+1,0), the ±1 order diffracted lights B(+1,+1), B(+1,−1), and the +2 order diffracted light (+1,+2) of the incident +1 order diffracted light B(+1); and the 0 order light B(−1,0), the ±1 order diffracted lights B(−1,+1), B(−1,−1), and the −2 order diffracted light B(−1,−2) of the incident −1 order diffracted light B(−1). The 2 order diffracted lights B(+1,+2), B(−1,−2) and the even number order diffracted lights of the 4th or higher orders, which are brought about by the diffraction grating 34Y, have extremely small intensities, because the expression (7) approximately holds. Therefore, in order to avoid any complication, parts of the diffracted lights having the weak intensities as described above are omitted from the illustration.

The 0 order light B(0,0) is radiated in the −Z, direction from the diffraction grating 34Y. The angle of diffraction θ2 of the +1 order diffracted light B(0,+1) is as follows by using the wavelength λ of the illumination light IL and the pitch P2 of the diffraction grating 34Y; and the angle of diffraction of the −1 order diffracted light B(0,−1) is −θ2.

sin θ2=λ/P2 (8)

The angle of diffraction (angle with respect to the −Z direction) θ21 of the 0 order light B(+1,0) of the +1 order diffracted light B(+1), which is brought about by the diffraction grating 34Y, is as follows by using the relationships of the expressions (6) and (8). That is, the angle of diffraction of the 0 order light B(−1,0) of the −1 order diffracted light B(−1) symmetrical to the +1 order diffracted light B(+1), which is brought about by the diffraction grating 34Y, is −θ21. Therefore, there is given sin θ21=−λ/(β·P1). The expression (9) is obtained by applying the expressions (6) and (8) to this expression. When the both sides of the expressions (9) are compared with each other, the absolute value of the angle of diffraction θ21 is approximately ½ of the angle of diffraction θ2.

sin θ21=−λ/(β·P1)=−λ/(2·P2)=−sin θ2/2 (9)

In this case, the angle of diffraction θ2x of the +1 order diffracted light B(+1,+1) of the +1 order diffracted light B(+1), which is brought about by the diffraction grating 34Y, fulfils the following relationship.

sin θ2x−sin θ21=λ/P2 (10)

When the expressions (9) and (10) are compared with each other, the angle of diffraction θ2x is equal to the angle of diffraction (−θ21) of the 0 order light B(−1,0) as follows.

sin θ2x=λ/(2·P2)=−sin θ21 (11)

Therefore, the +1 order diffracted light B(+1,+1) and the 0 order light B(−1,0), which are irradiated from the diffraction grating 34Y, are parallel to each other, and the main lights are overlapped with each other and cause the interference with each other to thereby generate a shearing interference light. C2. Similarly, the 0 order light B(+1,0) and the −1 order diffracted light B(−1,−1) which are irradiated from the diffraction grating 34Y, are parallel to each other, and the main lights are overlapped with each other and cause the interference with each other to thereby generate a shearing interference light C1. The shearing interference lights C1, C2 are received by the image pickup element 38 as an interference wavefront formed by the interference between the +1 order diffracted light B(+1) and the −1 order diffracted light B(−1) deviated laterally in the Y direction by the shear amount δy on the pupil plane PPL of the projection optical system PL respectively.

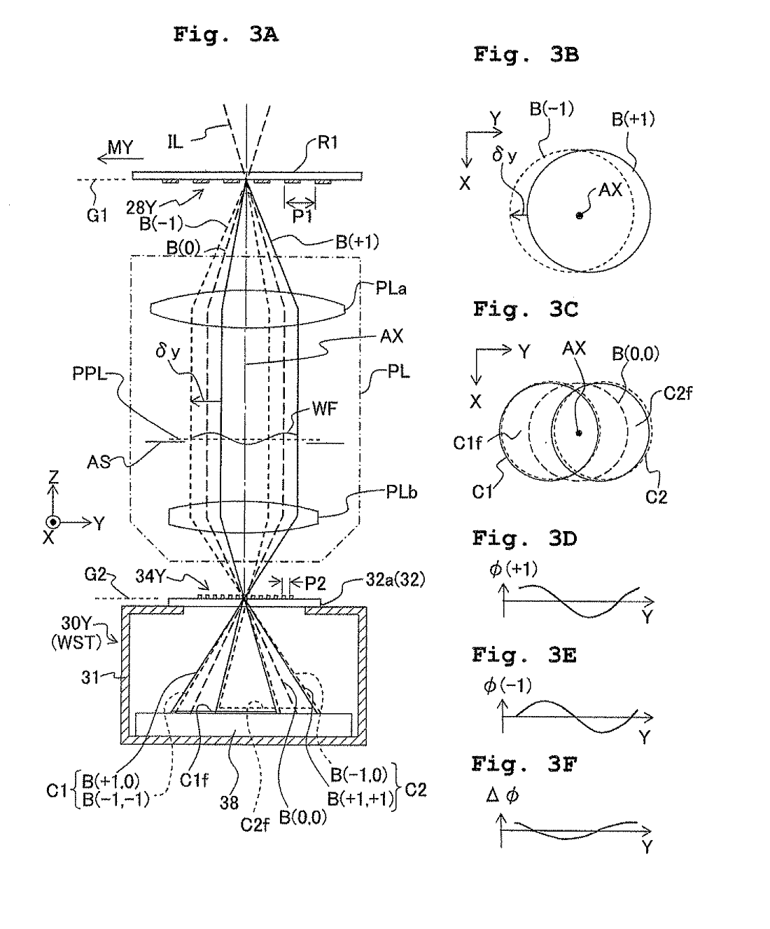

FIG. 3A illustrates the diffracted lights B(+1,0), B(−1,−1), B(−1,0), B(+1,+1) shown in FIG. 2 in considering that the illumination light IL is a light flux having a predetermined numerical aperture. That is, in FIG. 3A, not only the main lights of the respective diffracted lights are depicted, but the respective diffracted lights are also depicted as light fluxes having numerical apertures (angle ranges), wherein the boundary lines (outer boundaries) thereof are shown in the drawing. In FIG. 3A, the ±1 order diffracted lights B(+1), B(−1), which are irradiated from the diffraction grating 28Y, pass through substantially circular areas which are separated from each other by the shear amount δy in the Y direction as shown in FIG. 3B, on the pupil plane PPL of the projection optical system PL. The shearing interference light C1, in which the 0 order light B(+1,0) and the −1 order diffracted light B(−1,−1) are overlapped with each other, the 0 order light B(0,0), and the shearing interference light C2, in which the +1 order diffracted light B(+1,+1) and the 0 order light B(−1,0) are overlapped with each other, come into the image pickup element 38 shown in FIG. 3A, and are irradiated onto substantially circular areas which are positionally deviated or shifted from one another in the Y direction as shown in FIG. 3C respectively. As a result, interference fringes C1f, C2f appear on the light-receiving surface of the image pickup element 38.

In a case that the application is made to the exposure apparatus, as an example, the light-receiving surface of the image pickup element 38 is arranged at a position separated (away) by several mm in the Z direction from the diffraction grating 34Y. The numerical aperture NA of the projection optical system PL is large, i.e., not less than 0.8, and the sizes of the diffraction grating 34Y in the X direction and the Y direction are small, i.e., about 0.1 mm. Therefore, the light-receiving surface of the image pickup element 38 can be regarded as a surface or plane which is substantially conjugate with the pupil plane PPL of the projection optical system PL. Therefore, one point on the light-receiving surface of the image pickup element 38 corresponds to one point in the pupil plane PPL of the projection optical system PL.

In a state that there is no aberration of the projection optical system PL, there is no aberration, i.e., there is no phase difference between the optical path for the +1 order diffracted light B(+1) and the optical path for the −1 order diffracted light B(−1) which are separated from each other by the shear amount δy on the pupil plane PPL of the projection optical system PL. Therefore, the interference fringes C1f, C2f of the shearing interference lights C1, C2, which are brought about on the light-receiving surface of the image pickup element 38, have a uniform intensity on the entire surface.

On the other hand, in a state that there is any aberration in the projection optical system PL, the phase difference, which corresponds to the aberration, arises between the optical path for the +1 order diffracted light B(+1) and the optical path for the −1 order diffracted light B(−1) which are separated from each other by the shear amount δy. Therefore, gentle distribution of bright and dark fringes (lines) arises in each of the interference fringes C1f, C2f depending on the phase difference. That is, the following tendency is provided. In a case that the phase difference is close to an integral multiple of the half wavelength, the +1 order diffracted light B(+1) and the −1 order diffracted light B(−1) cause the interference to be dark. In a case that the phase difference is close to an integral multiple of the wavelength, the +1 order diffracted light B(+1) and the −1 order diffracted light B(−1) cause the interference to be bright.

Therefore, the shape of the distribution of the bright and dark fringes is imaged or picked up by the image pickup element 38. The information (wavefront information) of the wavefront WF of the projection optical system PL can be calculated based on the obtained signal as well.

It is assumed that the wavefront WF is restored from the intensity distribution of the interference fringes C1f of the shearing interference light C1. On this assumption, the two diffracted lights, i.e., the diffracted light B(+1,0) and the diffracted light B(−1,−1), which form the interference fringes C1f of the shearing interference light C1, are the diffracted lights B(−1) and the diffracted light B(−1) before passing through the diffraction grating 34Y respectively, and these lights have passed through the pupil plane PPL of the projection optical system PL while being deviated from each other in the Y direction by 5y.

Therefore, assuming that the wavefront WF is an ideal wavefront having a constant period, the diffracted light B(−1,0) and the diffracted light B(−1,−1), which are irradiated onto the image pickup element 38, have the wavefront aberrations which are shifted from each other in the Y direction depending on the deviation amount δy.

The phase distribution of the diffracted light B(−1,0), which is provided on a straight line parallel to the Y axis and allowed to pass through the optical axis AX on the image pickup element 38 shown in FIG. 3A, resides in, for example, a phase φ(+1) shown in FIG. 3D. The phase distribution of the diffracted light B(−1,−1), which is provided on the straight line, resides in a phase φ(−1) which is obtained by moving the phase φ(+1) by the shear amount δy as shown in FIG. 3E. Therefore, the phase distribution of the interference fringes C1f of the shearing interference light C1 in an area on the light-receiving surface of the image pickup element 38, which corresponds to the straight line, resides in a phase Δφ as the difference between the phase φ(+1) and the phase φ(−1) as shown in FIG. 3F (the phase Δφ (phase difference) is zero in a case that there is no wavefront aberration; on the other hand, in a case that the wavefront aberration exists, the phase Δφ is not zero based on the phase difference of the wavefront WF at the two positions separated from each other by the shear amount δy). The phase Δφ can be determined from the intensity distribution of the interference fringes C1f (light intensity detected for each of a plurality of pixels of the image pickup element 38). Therefore, the phase φ(+1) of the +1 order diffracted light (+1) as well as the phase distribution of the wavefront WF of the projection optical system PL can be restored by integrating (adding-up) the phase Δφ; and thus the wavefront aberration can be determined from the phase distribution.

When the diffraction grating 28Y and the diffraction grating 34Y are moved relative to each other in the Y direction in this state, the intensities of the interference fringes C1f, C2f are periodically changed to be bright and dark as a whole, on account of the following reason. That is, the phases of the diffracted light B(+1) and the diffracted light (−1) are deviated in the opposite directions in accordance with the relative movement of the diffraction grating 28Y and the diffraction grating 34Y. If the sum of the phase deviations is close to λ/2 (or an odd number multiple thereof), the dark pattern appears; and if the sum of the phase deviations is close to λ (or an integral multiple thereof), the bright pattern appears. Actually, the wavefront aberration remains to some extent in the projection optical system PL as indicated by the wavefront (phase distribution) WF on the pupil plane PPL. Therefore, the intensity distribution arises in the interference fringes C1f, C2f depending on the wavefront WF as described above even before the diffraction grating 28Y and the diffraction grating 34Y are moved relative to each other.

The intensity distribution is changed in a form of sine function in accordance with the relative movement in the Y direction of the diffraction grating 28Y and the diffraction grating 34Y. Accordingly, the intensity distributions of the interference fringes C1f, C2f can be determined by the wavefront information arithmetic section 7 shown in FIG. 1, and the wavefront WF of the projection optical system PL as well as the wavefront aberration can be also determined from the intensity distributions.

Although details will be described later on, as an example, the wavefront aberration can be specifically determined as follows. At first, the intensity distributions of the interference fringes C1f, C2f, which are formed on the image pickup element 38, are measured while moving the diffraction grating 28Y and the diffraction grating 34Y relative to each other in the Y direction, and the intensity distributions are stored in the storage device. Further, as an example, the intensity distribution is measured every time when the movement is performed by a distance corresponding to 1/16 of one pitch of the diffraction grating 28Y, and the measurement is performed for an amount of one pitch, i.e., 16 times.

The intensity distributions of the interference fringes C1f, C2f are changed in a form of sine wave with respect to the relative positional change of the diffraction grating 28Y and the diffraction grating 34Y. Therefore, the phase [rad] of the sine wave is calculated at each point (position of each of the pixels) on the image pickup element 38. In this case, the phase, which corresponds to the positional change by one pitch of the diffraction grating 28Y, is 2π [rad].

As described above, the light-receiving surface of the image pickup element 38 can be regarded to be substantially conjugate with the pupil plane PPL of the projection optical system PL. Therefore, the relative value of the phase at each point on the image pickup element 38 corresponds to the difference amount of the wavefront aberration of the projection optical system PL. In this case, the unit of the difference amount is [rad]. When this is multiplied by λ/2π (λ is the wavelength of the detecting light), the wavefront aberration can be calculated by using the length as the unit.

As shown in FIG. 2, the 0 order light B(0,0) and the ±1 order diffracted lights B(0,+1), B(0,−1), which exit from the diffraction grating 34Y, are also irradiated onto the image pickup element 38. However, the lights B(0,0), B(0,+1), B(0,−1) are the lights composed of the single diffracted lights. That is, the single lights are not generated by the interference between the diffracted lights, unlike the shearing interference light. Therefore, the intensity distributions of the lights, which are formed on the image pickup element 38 by the lights B(0,0), B(0,+1), B(0,−1), are not changed at all by the relative movement in the Y direction of the diffraction grating 28Y and the diffraction grating 34Y as described above. Therefore, even when these diffracted lights are irradiated onto the image pickup element 38, the measurement accuracy of the wavefront aberration is not lowered or deteriorated.

As shown in FIG. 2, as for the image pickup element 38, a pair of the −1 order diffracted light B(+1,−1) and the −2 order diffracted light B(−1,−2) are also irradiated onto the image pickup element 38 as the shearing interference lights which are parallel to each other and in which the main lights are overlapped with each other. However, the −2 order diffracted light B(−1,−2) has a small intensity, or the intensity is substantially zero. Therefore, the measurement accuracy of the wavefront aberration is not lowered thereby. This situation is also holds in the same manner as described above in relation to the pair of the +1 order diffracted light B(−1,+1) and the +2 order diffracted light B(+1,+2).

Although not shown in FIG. 2, there are shearing interference lights based on the higher order diffracted lights (for example, a pair of the −3 order light of the −1 order light generated from the diffraction grating 28Y as brought about by the diffraction grating 34Y and the −2 order light of the +1 order light generated from the diffraction grating 28Y as brought about by the diffraction grating 34Y and a pair of the −4 order light of the order light generated from the diffraction grating 28Y as brought about by the diffraction grating 34Y and the −3 order light of the +1 order light generated from the diffraction grating 28Y as brought about by the diffraction grating 34Y). In any case, one of the diffracted lights is the even number order diffracted light brought about by the diffraction grating 341, and hence the intensity is small or the intensity is substantially zero. Therefore, the measurement accuracy of the wavefront aberration is not lowered thereby.

The reason, why any harmful influence is not substantially exerted as described above by the diffracted lights, other than the shearing interference lights C1, C2 suitable for the measurement of the wavefront information, among the diffracted lights irradiated onto the image pickup element 38 in this embodiment and another embodiment described later on, is that the pitch P1 of the diffraction grating 28Y arranged on the object plane side and the pitch P2 of the diffraction grating 34Y arranged on the image plane side are optimized.

In this embodiment and another embodiment described later on, the interference fringes, which are formed on the image pickup element 38, do not include a bright/dark pattern of the so-called striped pattern in which the bright and dark regions are repeated while providing a period of predetermined length.

Although the explanation is omitted from the foregoing description in order to avoid any complication, the higher order diffracted lights are also actually generated from the diffraction grating 28Y arranged on the object plane of the projection optical system PL shown in FIG. 2. The higher order diffracted lights are also transmitted through the projection optical system PL, and are irradiated onto the diffraction grating 34Y arranged on the image plane; and the higher order diffracted lights are diffracted thereby again, and are irradiated onto the image pickup element 38.

The sign of the amplitude of the higher order diffracted light as described above, i.e., 0 or π [rad] of the phase is changed depending on the ratio of a width D1Yb of the transmitting portion 28Yb of the diffraction grating 28Y with respect to the pitch of the diffraction grating 28Y formed of the light shielding portion 28Ya and the light transmitting portion 28Yb as approved by the general diffraction theory.

In this embodiment and another embodiment described later on, it is desirable that the relationship of the width D1Yb of the transmitting portion of the diffraction grating 28Y with respect to the pitch 21 is as follows in order to optimize the intensity and the phase of the higher order diffracted light from the diffraction grating 28Y and to form the satisfactory interference fringes on the image pickup element 38.

0.1×P1≦D1Yb≦0.4×P1 (12)

On the other hand, for example, if the width D1Yb of the transmitting portion 28Yb is larger than 0.4×P1 in contravention of the above, then the 3 order diffracted light from the diffraction grating 28Y has a relatively large intensity as well as the antiphase as compared with the 1 order diffracted light, and an interference component which acts as the noise is generated on the image pickup element 38. On the contrary, if the width D1Yb of the transmitting portion 28Yb is smaller than 0.1×P1, then the light amount transmitted through the diffraction grating 28Y is decreased, and it is difficult to measure the wavefront information highly accurately at a high speed.

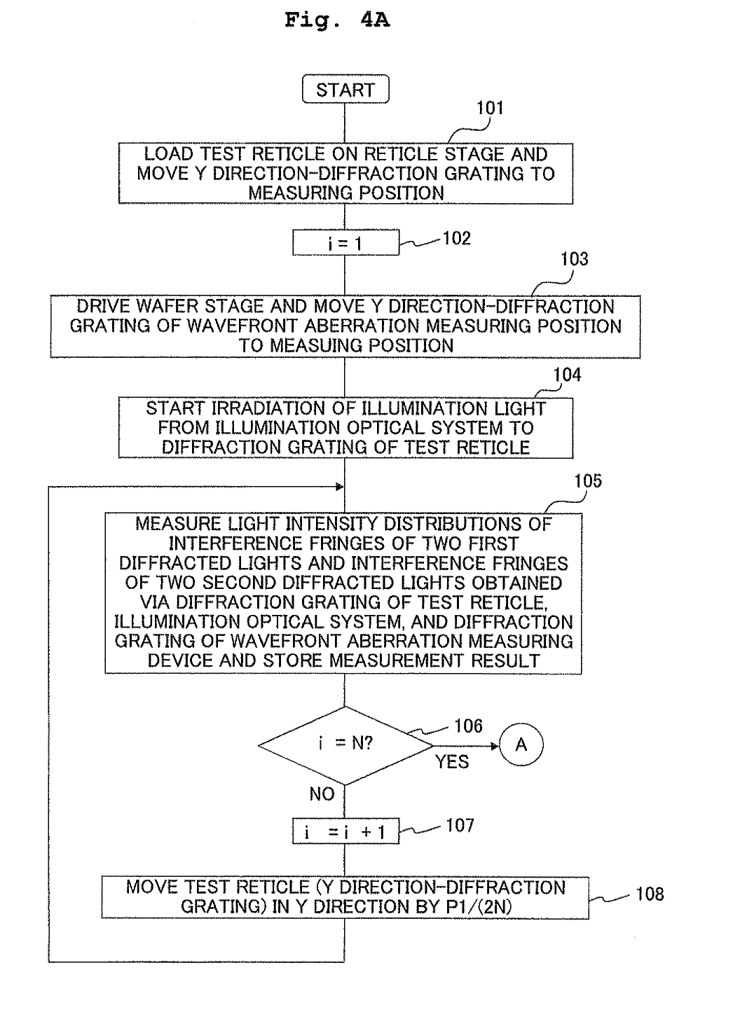

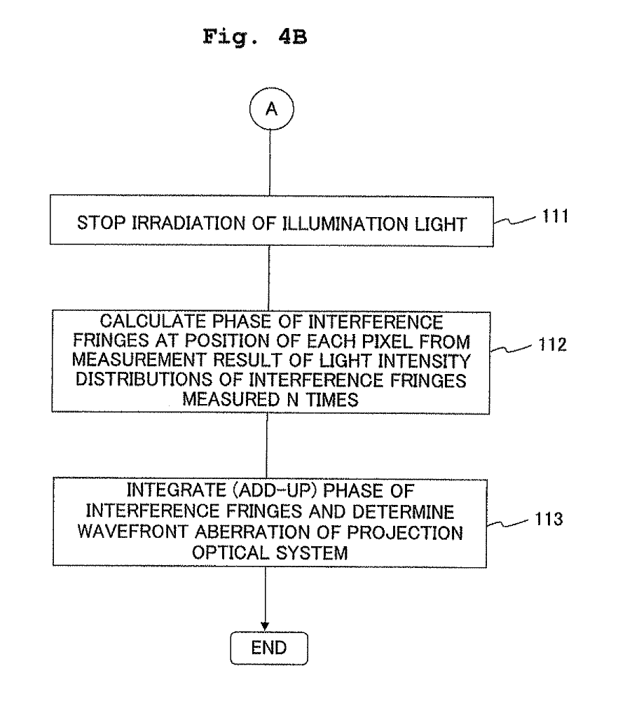

An explanation will be made below, with reference to a flow chart shown in FIG. 4 (FIGS. 4A, 4B), about an example of the operation for performing on-body measurement of the wavefront aberration of the projection optical system PL by using the measuring apparatus including the wavefront measuring unit 30Y and the diffraction grating 28Y of the test reticle R1 shown in FIG. 2. The operation is controlled by the main control system 2, and the operation is periodically executed, for example, during the exposure step.

At first, in Step 101 shown in FIG. 4 (FIGS. 4A, 4B), the test reticle R1 is loaded on the reticle stage RST. The Y direction-diffraction grating 28Y is moved to the measuring position as shown in FIG. 2, and the diffraction grating 28Y is allowed to stand still at this position. Subsequently, the integer control parameter i is set to 1 in a controller included in the main control system 2 (Step 102). The wafer stage WST is driven, and the Y direction-diffraction grating 34Y of the wavefront measuring unit 30Y is moved to a position (measuring position) of the image of the diffraction grating 28Y (Step 103). The wavefront measuring unit 30Y (diffraction grating 34Y) is allowed to stand still at this position, and then the irradiation of the illumination light IL is started from the illumination optical system ILS with respect to the diffraction grating 28Y (Step 104).

Subsequently, in Step 105, as shown in FIG. 3A, the intensity distribution (light intensity distribution) of the entire interference fringes, including the interference fringes C1f of the shearing interference light C1 (interference light of the two first diffracted lights B(+1,0), B(−1,−1)), the 0 order light B(0,0), and the interference fringes C2f of the shearing interference light C2 (interference light of the two second diffracted lights B(−1,0), B(+1,+1)), which is obtained via the diffraction grating 28Y, the projection optical system PL and the diffraction grating 34Y, is measured by the image pickup element 38 and the wavefront information arithmetic section 7. According to the measurement result, for example, the intensity distribution of only the interference fringes C1f, as one of the interference fringes C1f and Cf2, is determined. The obtained intensity distribution is stored in a storage section (device) of the wavefront information arithmetic section 7. The measurement result is stored as a light intensity I0(x,y) for each of the pixels provided that the coordinates in the X direction and the Y direction of each of the pixels of the image pickup element 38 are represented by (x,y).

For example, the intensity distribution of the entire interference fringes described above may be stored and used for the following process, instead of the intensity distribution of only the interference fringes C1f as the one interference fringe among the interference fringes.

Subsequently, the main control system 2 judges whether or not the control parameter i arrives at a predetermined integer N (N is, for example, an integer of not less than 4) (Step 106). At this stage, i<N is given. Therefore, the operation proceeds to Step 107, and the main control system 2 adds 1 to the control parameter i. After that, the stage driving system 4 is driven to drive the reticle stage RST; the test reticle R1 (diffraction grating 28Y) is moved, for example, in a movement direction MY of the −Y direction by P1/(2N) with reference to FIG. 3A (Step 108); and the operation is returned to Step 105. Accordingly, the phases of the 1 order diffracted lights B(+1), B(−1) are changed in the opposite directions by 2π/(2N) [rad] respectively. Therefore, the phase of the interference fringes C1f is changed by 2π/N [rad].

The intensity distributions of the interference fringes C1f, C2f of the shearing interference lights C1, C2 and the 0 order light B(0,0), which are obtained via the diffraction grating 28Y, the projection optical system PL, and the diffraction grating 34Y, are measured by the image pickup element 38 and the wavefront information arithmetic section 7. The intensity distribution of only the interference fringes C1f, which is obtained from the measurement result, is stored as a light intensity I1(x,y) of each of the pixels in the storage section of the wavefront information arithmetic section 7. For example, the intensity distribution of the entire interference fringes may be stored and used for the following process, instead of the intensity distribution of only the interference fringes C1f as the one interference fringe among the interference fringes.

After that, those repeated are the movement of the test reticle R1 (diffraction grating 28Y) in the movement direction MY by P1/(2N) in Step 108, the measurement of the intensity distribution of the interference fringes C1f of the shearing interference light C1 in Step 105, and the storage of the light intensity Ii−1(x,y) (i=1, 2, . . . , N) for each of the pixels as the measurement result thereof, until the control parameter i arrives at N. If the control parameter i arrives at N in Step 106, then the operation proceeds to Step 111, and the irradiation of the illumination light IL is stopped.

Subsequently, in Step 112, the wavefront information arithmetic section 7 calculates the phase Δφ(x,y) of the interference fringes C1f at the position (x,y) of each of the pixels of the image pickup element 38 from the measurement result (light intensity Ii−1(x,y)) of the intensity distribution of the interference fringes C1f performed N times in Step 105. As an example, if the integer N is 4, then the light intensities of each of the pixels for the measured interference fringes are I0(x,y), I1(x,y), I2(x,y), and I3(x,y), and the phase Δφ(x,y) can be calculated as follows.

Δφ(x,y)=arctan {(I3(x,y)−I1(x,y))/(I0(x,y)−I2(x,y))}=arctan(b/a) (13)

The difference amount calculation is included in this calculation (arithmetic operation). Therefore, the influence of the 0 order light B(0,0) is offset more completely. If the value of N is any value other than 4, a calculation expression corresponding thereto is used. The main value of arctan is usually within a range of −π/2 to π/2. However, in the case of the expression (13), the quadrant of the phase can be judged from the signs of the numbers a, b. Therefore, the phase can be specified within a range of −π to π (or, for example, 0 to 2π). The interference fringes in this embodiment reside in the wavefront (difference wavefront) of the shearing interference light C1, and the phase Δφ(x,y) is usually within a range of ±π. Therefore, it is possible to use the expression (13) as it is. If the phase Δφ(x,y) exceeds the range of ±π, it is appropriate to perform the well-known phase connecting technique.

Subsequently, in Step 113, the wavefront information arithmetic section 7 integrates (or adds-up) the Δφ(x,y) in the Y direction to determine the phase distribution, i.e., the wavefront WF of the +1 order diffracted light B(+1) on the pupil plane PPL of the projection optical system PL. Further, the wavefront WF is expanded, for example, in accordance with the Zernike's polynomials to determine the coefficients of the respective orders. Thus, the wavefront aberration can be determined. The information of the wavefront aberration determined as described above is supplied to the main control system 2, and the measurement of the wavefront aberration is completed. For example, the information of the wavefront aberration is used in the main control system 2 to correct the driving amount of the imaging characteristic correcting mechanism described above. Accordingly, the imaging characteristic of the projection optical system PL can be always maintained in a satisfactory state. Steps 101 to 113 can be performed at any arbitrary stage before or after the exposure operation for the wafer W. Steps 101 to 113 can be performed, for example, during the exchange of the reticle, after the completion of the exposure for the wafers W of a predetermined lot number by using a specified reticle, or during the maintenance for the exposure apparatus.

Basically, the interference fringes C1f of the shearing interference light C1 and the interference fringes C2f of the shearing interference light C2 are same interference fringes. The two interference fringes are formed on the image pickup element 38 while being deviated from each other in the Y direction by a predetermined distance corresponding to the shear amount δy on the pupil plane PPL. In view of the above, in order to more accurately measure components having higher frequencies of the wavefront information of the projection optical system PL, it is desirable in some cases to perform a process (single image forming process) in which the two interference fringes, which are deviated from each other in the Y direction, are converted into one interference fringes.

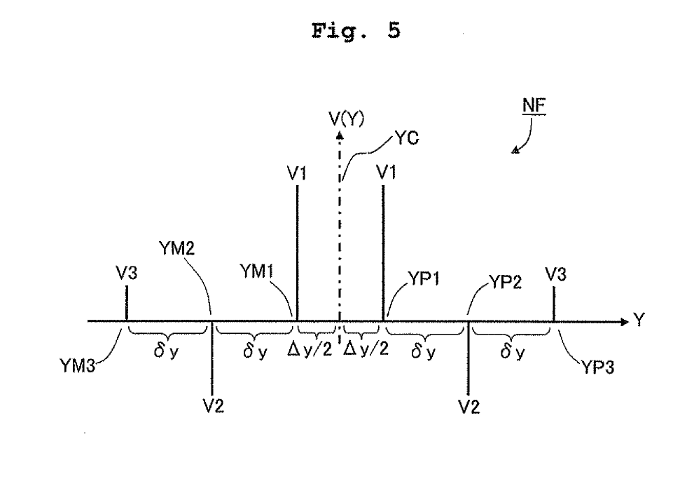

As an example of the single image forming process, it is appropriate to perform, in the wavefront information arithmetic section 7, a convolution operation (calculation) by using a numerical filter as shown in FIG. 5, with respect to a signal (two-dimensional image information) detected by the image pickup element 38.

FIG. 5 shows an example of one-dimensional numerical filter NF suitable for the single image forming process by way of example. The horizontal axis in FIG. 5 represents position in the Y direction, and the vertical axis represents a value V(Y) at a position Y. The numerical filter NF has a positive value V1 at two points YP1, YM1 separated from a reference point YC in the ±Y directions by δy/2; the numerical filter NF has a negative value V2 at two points YP2, YM2 separated further therefrom by δy; and the numerical filter NF has a positive value V3 at two points Y23, YM3 separated further therefrom by δy. The value is 0 at all points other than the foregoing points on the Y axis. It is assumed that V3=0.2×V1 and V2=−0.4×V1 are given.

The signal, which is detected by the image pickup element 38, is subjected to the convolution by using the numerical filter NF in the wavefront information arithmetic section 7, and thus it is possible to perform the single image forming process for the interference fringes. The ratios among the values V1, V2, V3 of the numerical filter NF are not limited to the above. The ratios may be set depending on the degree of necessity of the high frequency components of the wavefront information.

The single image forming process can be also performed as follows. That is, the signal, which is detected by the image pickup element 38, is subjected to the Fourier transform, the high frequency enhancing process is performed for an obtained result, and an obtained result is subjected to the Fourier inverse transform.

The function, the effect, etc. of this embodiment are as follows.

(1) The wavefront aberration measuring apparatus of this embodiment is the apparatus measuring the wavefront aberration of the projection optical system PL, including: the diffraction grating 28Y which is arranged on the object plane side of the projection optical system PL; the diffraction grating 34Y which is arranged on the image plane side of the projection optical system PL and which has the pitch P2 that is ½ of the pitch β·P1 of the image of the diffraction grating 28Y; the illumination optical system ILS which illuminates the diffraction grating 28Y with the illumination light IL; the image pickup element 38 which detects the intensity distribution of the interference fringes including the interference fringes C1f, C2f of the plurality of diffracted lights (including the 0 order light) formed by the illumination light IL via the diffraction grating 28Y, the projection optical system PL, and the diffraction grating 34Y; and the wavefront information arithmetic section 7 (arithmetic or calculating device) which determines the wavefront aberration of the projection optical system PL based on the detection result of the image pickup element 38.

The method for measuring the wavefront aberration of the projection optical system PL, which uses the measuring apparatus, includes; arranging the diffraction grating 28Y on the object plane side of the projection optical system PL (Step 101); arranging the diffraction grating 34Y on the image plane side of the projection optical system PL (Step 103); illuminating the diffraction grating 28Y with the illumination light IL (Step 104); receiving the interference fringes C1f, C2f formed by the illumination light via the diffraction grating 28Y, the projection optical system PL, and the diffraction grating 34Y (Step 105); and determining the wavefront aberration of the projection optical system PL based on the received interference fringes (Steps 112, 113).

According to this embodiment, it is possible to make the size of the diffraction grating 28Y, which is arranged on the object side of the projection optical system PL, be sufficiently larger than the resolution limit of the projection optical system PL.

That is, according to this embodiment, it is possible to avoid the drastic decrease in the light amount which would be otherwise caused by the provision of the minute aperture which is approximate to the resolution limit on the object plane side of the projection optical system, unlike any conventional apparatus which adopts the shearing method, the PDT method, or the Shack-Hartmann method. Therefore, it is possible to obtain the large light amount on the image pickup element 38, and it is possible to measure the wavefront information highly accurately at a high speed.

The relationship between the pitch P1 of the diffraction grating 28Y arranged on the object side of the projection optical system PL and the pitch P2 of the diffraction grating 34Y arranged on the image plane side is optimized. Therefore, it is possible to suppress the influence of the noise resulting from the higher order diffracted lights generated from the diffraction grating 34Y, and it is possible to highly accurately measure the wavefront information of the projection optical system PL.

(2) The first interference fringes C1f to be detected are the interference fringes of the shearing interference light C1 brought about by the −1 order diffracted light B(−1,−1) from the diffraction grating 34Y as brought about by the −1 order diffracted light (1 order light) from the diffraction grating 28Y and the 0 order light B(+1,0) from the diffraction grating 34Y as brought about by the +1 order diffracted light (1 order light) from the diffraction grating 28Y. The second interference fringes C2f to be detected are the interference fringes of the shearing interference light C2 brought about by the +1 order diffracted light B(+1,+1) from the diffraction grating 34Y as brought about by the +1 order diffracted light from the diffraction grating 28Y and the 0 order light B(−1,0) from the diffraction grating 34Y as brought about by the −1 order diffracted light from the diffraction grating 28Y. Therefore, the wavefront aberration of the projection optical system PL can be measured by the shearing interference method.

(3) The detected interference fringes C1f, C2f do not include the so-called striped pattern in which the bright and dark regions are repeated at a period of predetermined length, for the following reason. That is, the pitch P2 of the diffraction grating 34Y is ½ of the pitch of the image of the diffraction grating 28Y; the shearing interference lights C1, C2 are composed of the two diffracted lights travelling in the same direction respectively; and the grating pattern of the diffraction grating 34Y having the pitch P2 described above is not reflected on the image pickup element 38. Therefore, the wavefront of the projection optical system PL can be correctly restored from the intensity distribution of the interference fringes C1f (or C2f) irrelevant to the distance from the diffraction grating 34Y to the image pickup element 38.

(4) In this embodiment, the operation, in which the diffraction grating 28Y is moved by P1/(2N) in the periodic direction (Step 108) and the intensity distribution of the interference fringes C1f of the shearing interference light C1 is measured (Step 105), is repeated a plurality of times. Therefore, the measurement results, which are obtained by repeating the operation the plurality of times, are subjected to the arithmetic process (Step 112), and by doing so, the phase distribution of the interference fringes C1f can be correctly determined even in a case that the intensity (amplitude) of the interference fringes C1f differs for each of the pixels of the image pickup element 38.

The intensity distribution of the interference fringes C1f may be measured a plurality of times while allowing the diffraction grating 28Y on the object plane side to stand still and moving the diffraction grating 34Y on the image plane side in the periodic direction.

(5) The calculation expression (13), which is provided to determine the phase Δφ(x,y) of the interference fringes C1f, can be also regarded such that the change of the light amount, which is provided with respect to the movement of the diffraction grating 28Y (or the diffraction grating 34Y) in the periodic direction, is detected substantially in the light-receiving surface of the image pickup element 38 which receives the interference fringes C1f, and that the phase Δφ(x,y) is determined based on the detection result. The influence of the 0 order light B(0,0) generated from the diffraction grating 34Y can be offset by detecting the change of the light amount. The wavefront and the wavefront aberration of the projection optical system PL can be determined by integrating the phase Δφ(x,y).

(6) The exposure apparatus 100 of this embodiment is the exposure apparatus for illuminating the pattern of the reticle R with the illumination light IL from the illumination optical system ILS and exposing the wafer W with the illumination light IL via the pattern and the projection optical system PL, including the wavefront aberration measuring apparatus of this embodiment in order to determine the wavefront aberration of the projection optical system PL, wherein the illumination optical system ILS is used as the illumination system for the measuring apparatus. Therefore, the wavefront aberration of the projection optical system PL can be measured highly accurately by the on-body measurement. Further, it is unnecessary to provide any additional illumination system dedicated for the measuring apparatus.

The exposure method of this embodiment is the exposure method for illuminating the pattern of the reticle R with the illumination light IL and exposing the wafer W with the illumination light IL via the pattern and the projection optical system PL, wherein the wavefront aberration of the projection optical system PL is determined by using the wavefront aberration measuring method of this embodiment. Therefore, the wavefront aberration of the projection optical system PL can be determined highly accurately.

### Comparative Example

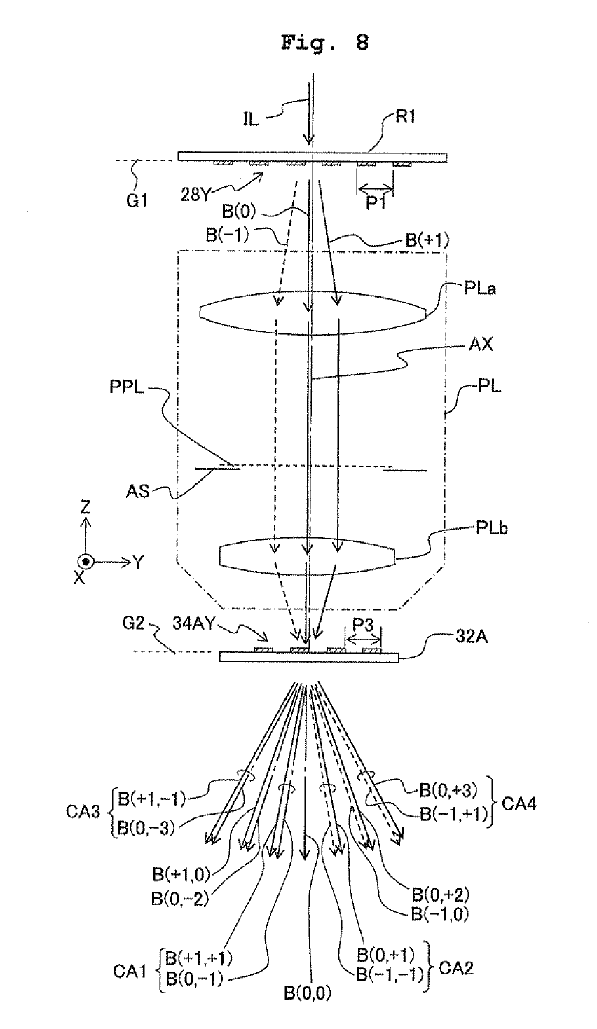

An explanation will be made with reference to FIG. 8 about Comparative Example in which the pitch of the diffraction grating on the image plane side of the projection optical system PL is set to be twice the pitch of the image of the diffraction grating on the object plane side of the projection optical system PL, unlike the embodiment described above. In FIG. 8, the components or parts, which correspond to those shown in FIG. 2, are designated by the same reference numerals.

With reference to FIG. 8, a diffraction grating 28Y, which has a pitch P1 in the Y direction and which is arranged on an object plane G1 of a projection optical system PL having the projection magnification β (β is, for example, ¼, ⅕ or the like), is illuminated with an illumination light IL. The 0 order light B(0) and the ±1 order diffracted lights B(−1), B(−1) are irradiated from the diffraction grating 28Y toward the projection optical system PL. A diffraction grating 34AY, which is formed at a pitch P3 in the Y direction on a glass plate 32A, is arranged on an image plane G2 of the projection optical system PL. The pitch P3 is twice the pitch of the image of the diffraction grating 28Y as follows.

P3=β×P1×2 (14)

The ratio (duty ratio) between the width of the light shielding portion and the width of the light transmitting portion of the diffraction grating 34AY is approximately 1:1. The intensities of the even number order diffracted lights generated from the diffraction grating 34AY are extremely small.

For example, those exiting from the diffracted light 34AY are the 0 order light B(0,0), the ±1 order diffracted lights B(0,+1), B(0,−1), and the ±3 order diffracted lights B(0,+3), B(0,−3) of the incident 0 order light B(0); the 0 order light B(+1,0), the ±1 order diffracted lights B(+1,+1), B(+1,−1), and the +3 order diffracted light (not shown) of the incident +1 order diffracted light B(+1); and the 0 order light B(−1,0), the ±1 order diffracted lights B(−1,+1), B(−1,−1), and the −3 order diffracted light (not shown) of the incident −1 order diffracted light B(−1). The ±2 order diffracted lights B(0,+2), B(0,−2), which are brought about by the 0 order light B(0) and which have extremely small intensities, are also shown in FIG. 8.

In this case, the +1 order diffracted light B(+1,+1) and the −1 order diffracted light B(0,−1), which are the ±1 order lights and which are included in the large number of diffracted lights generated from the diffraction grating 34AY, form the shearing interference light CA1 to travel in the same direction, and the +1 order diffracted light B(0,+1) and the −1 order diffracted light B(−1,−1) similarly form the shearing interference light CA2 to travel in the same direction so that the main components of the interference fringes formed on the image pickup element (not shown) are composed or constituted thereby.

However, in Comparative Example, the 3 order diffracted light and the higher odd number order diffracted lights, which are generated from the diffraction grating 34AY, also form the shearing interference lights. For example, a pair of the −1 order diffracted light B(+1,−1) and the −3 order diffracted light B(0,−3) and a pair of the +3 order diffracted light B(0,+3) and the +1 order diffracted light B(−1,+1) are included in this category.

Therefore, the interference fringes of the 3 order and higher odd number order shearing interference lights CA1 to CA4, which are generated from the diffraction grating 34AY, are formed as the noise on an image pickup element (not shown). Therefore, it is difficult to highly accurately determine the wavefront aberration of the projection optical system PL.

### Second Embodiment

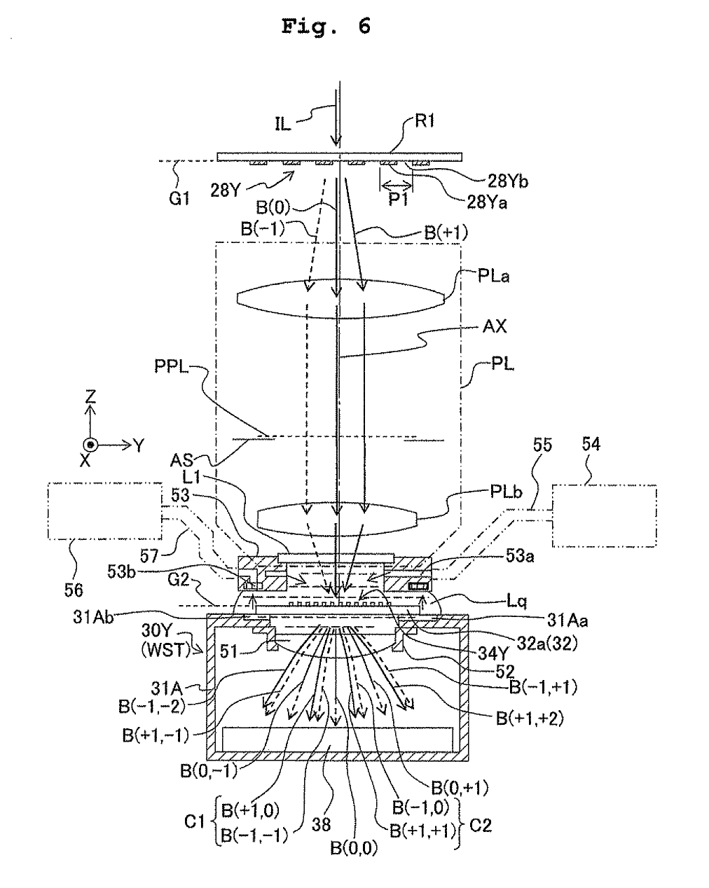

A second embodiment of the present invention will be explained with reference to FIG. 6. In this embodiment, the present invention is applied to measure the wavefront aberration of a projection optical system of an exposure apparatus performing the exposure in accordance with the liquid immersion method. In FIG. 6, the components or parts, which correspond to those shown in FIG. 2, are designated by the same reference numerals, any detailed explanation of which will be omitted.

FIG. 6 shows a wavefront aberration measuring apparatus for a projection optical system PL of this embodiment. With reference to FIG. 6, a diffraction grating 28Y, which has a pitch P1 in the Y direction, is arranged on an object plane G1 of the projection optical system PL. A diffraction grating 34Y of a glass plate 32a (glass plate 32) of a wavefront measuring unit 30AY is arranged on an image plane G2 of the projection optical system PL. The pitch in the Y direction of the diffraction grating 34Y is ½ of the pitch of the image of the diffraction grating 28Y. The exposure apparatus is provided with a local liquid immersion mechanism which supplies a liquid Lq (for example, pure water or purified water) transmitting the illumination light IL therethrough onto the entire surface of the glass plate 32 or to a part of a space (partial space) between the glass plate 32 and an optical element L1 disposed at the lowermost end of the projection optical system PL and which recovers the liquid Lq therefrom. The local liquid immersion mechanism supplies the liquid Lq only to the space between the optical element L1 and a partial area of the wafer during the exposure of the wafer W, and the local liquid immersion mechanism recovers the liquid Lq therefrom.

The local liquid immersion mechanism includes, as an example, a ring-shaped nozzle head 53 which surrounds the space on the bottom surface of the optical element L1, a liquid supply device 54 and a piping 55 which supply the liquid Lq to a supply port 53a of the nozzle head 53, and a liquid recovery device 56 and a piping 57 which recover (suck) the liquid Lq from the recovery port 53b of the nozzle head 53. Those usable as the liquid immersion mechanism include mechanisms disclosed, for example, in United States Patent Application Publication Nos. 2005/0248856 and 2007/242247, or European Patent Application Publication No. 1420298, etc.

The wavefront measuring unit 30AY, which is fixed to an unillustrated wafer stage WST, includes a glass plate 32a (diffraction grating 34Y), a condenser lens 51 which condenses or collects a plurality of diffracted lights generated from the diffraction grating 34Y to some extent, a lens holder 52 which supports the lens 51, a two-dimensional image pickup element 38 which receives the plurality of condensed diffracted lights, and a casing 31A which supports the glass plate 32a, the lens holder 52, and the image pickup element 38. Flow passages 31Aa, 31Ab, which are provided to allow the liquid Lq to pass therethrough, are formed at parts of the bottom surface of the glass plate 32a disposed at the upper surface of the casing 31A.

In a case that the wavefront aberration of the projection optical system PL is measured in this embodiment, the liquid Lq is supplied to a space between the glass plate 32a (diffraction grating 34Y) and the optical element L1 of the projection optical system PL in the same manner as in the exposure, and a space between the glass plate 32a and the lens 51 is also filled with the liquid Lq through the flow passages 31Aa, 31Ab. The diffraction grating 28Y is illuminated with the illumination light IL. The shearing interference light C1 (0 order light B(+1,0) and −1 order diffracted light B(−1,−1)) and the shearing interference light C2 (0 order light B(−1,0) and +1 order diffracted light B(+1,+1)), which are generated while passing through the diffraction grating 28Y, the projection optical system PL, and the diffraction grating 34Y, are received by the image pickup element 38. The wavefront aberration of the projection optical system PL is determined highly accurately from the intensity distributions of the interference fringes of the shearing interference lights C1, C2 in the same manner as in the first embodiment and under a same condition as the condition under which the exposure is performed in accordance with the liquid immersion method.

In the embodiments described above, the diffraction grating 28Y and the diffraction grating 34Y are the one-dimensional diffraction gratings. However, for example, two-dimensional diffraction gratings, which are formed to have predetermined pitches in the X direction and the Y direction, may be used as the diffraction grating 28Y and the diffraction grating 34Y.

In the embodiment shown in FIG. 2 described above, the ratio (duty ratio) between the width in the Y direction of the light shielding portion 28Y and the width in the Y direction of the transmitting portion 28Yb of the diffraction grating 28Y on the object plane of the projection optical system PL can also be set to approximately 1:1 as well. In this case, the intensities of the even number order diffracted lights including, for example the 2 order diffracted light and the 4 order diffracted light generated from the diffraction grating 28Y are weakened. Further, in a case that the duty ratio of the diffraction grating 28Y is set to approximately 1:1, it is also possible to provide a phase shift pattern in which the phases of the two adjacent transmitting portions 28Yb are 0 and π [rad]. In a case that the phase shift pattern is used, the 0 order light B(0) from the diffraction grating 28Y is approximately zero. Therefore, the ratio of the noise light is decreased with respect to the finally obtained interference fringes.

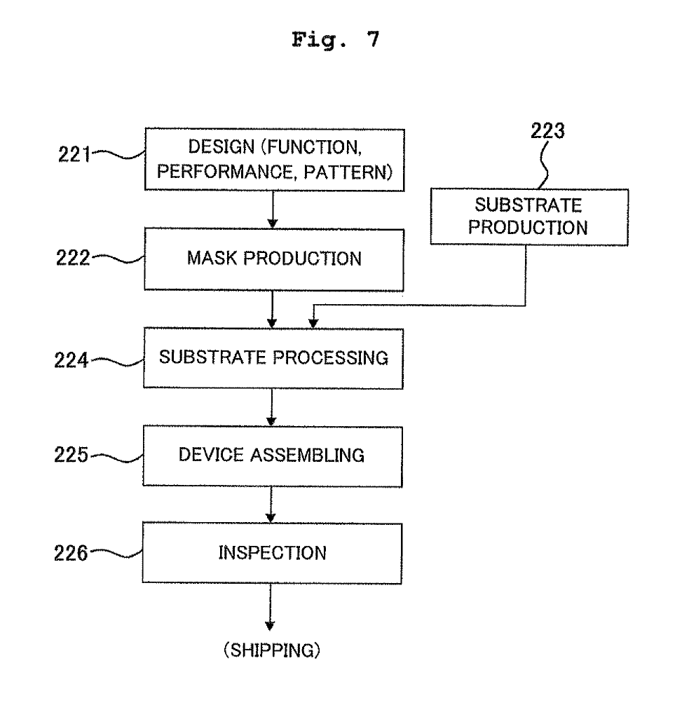

In a case that an electronic device such as a semiconductor device (or a microdevice) is produced by using the exposure apparatus 100 (exposure method) of the embodiment described above, as shown in FIG. 7, the electronic device is produced by performing a step 221 of designing the function and the performance of the electronic device; a step 222 of manufacturing a mask (reticle) based on the designing step; a step 223 of producing a substrate (wafer) as a base material for the device and coating a resist on the substrate (wafer); a substrate-processing step 224 including a step of exposing the substrate (photosensitive substrate) with a pattern of the reticle by the exposure apparatus (exposure method) of the embodiment described above, a step of developing the exposed substrate, a step of heating (curing) and etching the developed substrate, etc.; a step 225 of assembling the device (including processing processes such as a dicing step, a bonding step, and a packaging step); an inspection step 226; and the like.

In other words, the method for producing the device includes transferring the image of the pattern of the reticle to the substrate (wafer) by using the exposure apparatus 100 (exposure method) of the embodiment described above, and processing the substrate having been subjected to the transfer, depending on the image of the pattern (Step 224). In this procedure, according to the embodiment described above, the wavefront aberration of the projection optical system PL of the exposure apparatus can be measured highly accurately, for example, before or after the exposure step or during the exposure step; and according to the measurement result, the imaging characteristic of the projection optical system PL can be highly accurately maintained to be in the target state. Therefore, it is possible to produce the electronic device highly accurately.

The present invention is also applicable to a case using an exposure apparatus of the full field exposure type such as a stepper or the like, in addition to the case using the exposure apparatus of the scanning exposure type as described above.

Further, the present invention is also applicable in a case that the wavefront aberration is measured for a projection optical system of an EUV exposure apparatus which uses, as the exposure light, the extreme ultraviolet light (EUV light) having a wavelength of not more than about 100 nm. In the EUV exposure apparatus, the optical system is constructed of reflecting optical elements except for a specific filter, etc. and the reticle is of the reflection type as well. Therefore, it is allowable that, for example, a reflection type grating, in which a large number of minute dot patterns for reflecting the EUV light are periodically arranged, is used instead of the diffraction grating 28Y described above; and that a grating in which apertures are periodically provided for an EUV light-absorbing substrate, etc. is used instead of the diffraction grating 34Y.

The second embodiment has been explained as exemplified by the local liquid immersion exposure apparatus provided with the local liquid immersion mechanism by way of example. However, the present invention is applicable not only to those of the local liquid immersion type in which the liquid is allowed to intervene only in a local space between the projection optical system and the object (or a part of the object) but also to an exposure apparatus of the liquid immersion exposure type in which the entire object is immersed in the liquid. The present invention is also applicable to an exposure apparatus of the liquid immersion type in which the liquid immersion area between the projection optical system and the substrate is retained by an air curtain provided therearound.

The present invention is also applicable to a case of using an exposure method or an exposure apparatus of the multi-stage type provided with a plurality of stages as disclosed, for example, in U.S. Pat. Nos. 6,590,634, 5,969,441, and 6,208,407 and to an exposure method and an exposure apparatus provided with a measuring stage having a measuring member (a reference mark and/or a sensor, etc.) as disclosed, for example, in International Publication No. 1999/23692 and U.S. Pat. No. 6,897,963. In the case of the exposure apparatus provided with the measuring stage, the wavefront measuring units 30X, 30Y may be provided on the measuring stage.

The present invention is not limited to the application to the exposure apparatus for producing the semiconductor device. The present invention is also widely applicable, for example, to an exposure apparatus for a display apparatus including a liquid crystal display element formed on a square or rectangular glass plate, a plasma display, etc., and to an exposure apparatus for producing various devices including an image pickup element (CCD, etc.), a micromachine, a thin film magnetic head, MEMS (Microelectromechanical Systems), a DNA chip, etc. Further, the present invention is also applicable to an exposure step using the photolithography step to produce a mask (a photomask, a reticle, etc.) on which mask patterns for various devices are formed.

The disclosures of the published patent documents, the respective international publication pamphlets, the US patent documents, and the US patent application publication documents described in this application are incorporated herein by reference. The present invention is not limited to the embodiments described above, and may be embodied in other various forms within a scope without deviating from the gist or essential characteristics of the present invention.

What is claimed is:

1. A wavefront measuring method for measuring wavefront information of a projection optical system, the wavefront measuring method comprising:
arranging a first grating on a side of an object plane of the projection optical system;
arranging a second grating, having a pitch which is ½ of a pitch of an image of the first grating, on a side of an image plane of the projection optical system;
illuminating the first grating with an illumination light;
receiving interference fringes formed by the illumination light from the second grating via the first grating and the projection optical system; and
determining the wavefront information of the projection optical system based on the received interference fringes.

2. The wavefront measuring method according to claim 1, wherein the interference fringes include an interference component of a 1 order diffracted light from the second grating which is generated by illuminating the second grating with a +1 order diffracted light from the first grating and a 0 order diffracted light from the second grating which is generated by illuminating the second grating with a −1 order diffracted light from the first grating.

3. The wavefront measuring method according to claim 2, wherein the interference fringes do not include a striped pattern.

4. The wavefront measuring method according to claim 1, wherein the interference fringes are detected a plurality of times while moving the first grating or the second grating in a periodic direction.

5. The wavefront measuring method according to claim 4, wherein a change of a light amount with respect to the movement of the first grating or the second grating in the periodic direction is detected in a light-receiving surface receiving the interference fringes; and
the wavefront information of the projection optical system is determined based on a result of the detection.

6. The wavefront measuring method according to claim 1, wherein first transmitting portions through which the illumination light is transmitted and first light shielding portions which shield the illumination light are repeated on the first grating at a period of pitch P1; and
a width of each of the first transmitting portions is not less than 0.1 time the pitch P1 and not more than 0.4 time the pitch P1.

7. The wavefront measuring method according to claim 1, wherein the second grating has second transmitting portions through which the illumination light is transmitted and second light shielding portions which shield the illumination light; and
a ratio between a width of each of the second transmitting portions and a width of each of the second light shielding portions is 1:1.

8. The wavefront measuring method according to claim 1, wherein the pitch P1 of the first grating is within the following range provided that λ represents a wavelength of the illumination light and NAin represents a numerical aperture of the projection optical system on the side of the object plane:
4×λ/Nain≦P1≦200×λ/NAin

9. The wavefront measuring method according to claim 8, wherein the pitch P1 of the first grating fulfils the following expression:
8×λ/Nain≦P1≦100×λ/NAin.

10. The wavefront measuring method according to claim 1, wherein a single image forming process is performed for the interference fringes when the wavefront information of the projection optical system is determined based on the interference fringes.

11. The wavefront measuring method according to claim 1, further comprising supplying a liquid to an optical path for the illumination light ranging from the projection optical system to the second grating and an optical path for the illumination light ranging from the second grating to a predetermined surface, the illumination light being transmitted through the liquid.

12. The wavefront measuring method according to claim 1, wherein a coherence factor of the illumination light illuminating the first grating therewith is 0.8 to 1.

13. An exposure method for illuminating a pattern with an illumination light and exposing an object with the illumination light via the pattern and a projection optical system, the exposure method comprising:
determining wavefront information of the projection optical system by using the wavefront measuring method as defined in claim 1;
adjusting the projection optical system based on the determined wavefront information of the projection optical system; and
illuminating the object with the illumination light via the pattern and the adjusted projection optical system.

14. The exposure method according to claim 13, further comprising supplying a liquid to an optical path for the illumination light ranging from the projection optical system to the second grating and an optical path for the illumination light ranging from the second grating to a predetermined surface, the illumination light being transmitted through the liquid.

15. The exposure method according to claim 13, wherein light shielding portions and light transmitting portions are arranged alternately on the first grating while extending in a predetermined direction, and the interference fringes are detected while moving the first grating relative to the second grating in a direction perpendicular to the predetermined direction.

16. The exposure method according to claim 15, wherein the object is illuminated with the illumination light while synchronously moving the pattern and the object in the direction perpendicular to the predetermined direction.

17. A wavefront measuring apparatus which measures wavefront information of a projection optical system, the wavefront measuring apparatus comprising:
a first grating arranged on a side of an object plane of the projection optical system;
a second grating arranged on a side of an image plane of the projection optical system and having a pitch which is ½ of a pitch of an image of the first grating;
an illumination system which illuminates the first grating with an illumination light;
a photoelectric sensor which detects an intensity distribution of interference fringes formed by the illumination light from the second grating via the first grating and the projection optical system; and
an arithmetic section which determines the wavefront information of the projection optical system based on a detection result of the photoelectric sensor.

18. The wavefront measuring apparatus according to claim 17, wherein the interference fringes include an interference component of a 1 order diffracted light from the second grating which is generated by illuminating the second grating with a +1 order diffracted light from the first grating and a 0 order diffracted light from the second grating which is generated by illuminating the second grating with a −1 order diffracted light from the first grating.

19. The wavefront measuring apparatus according to claim 17, wherein the interference fringes do not include a striped pattern.

20. The wavefront measuring apparatus according to claim 17, further comprising a stage which moves the first grating or the second grating in a periodic direction;
wherein the arithmetic section determines the wavefront information based on an intensity distribution of the interference fringes measured a plurality of times via the photoelectric sensor when the first grating or the second grating is moved in the periodic direction by the stage.

21. The wavefront measuring apparatus according to claim 17, wherein first transmitting portions through which the illumination light is transmitted and first light shielding portions which shield the illumination light are repeated on the first grating at a period of pitch P1; and
a width of each of the first transmitting portions is not less than 0.1 time the pitch P1 and not more than 0.4 time the pitch P1.

22. The wavefront measuring apparatus according to claim 17, wherein the second grating has second transmitting portions through which the illumination light is transmitted and second light shielding portions which shield the illumination light; and
a ratio between a width of each of the second transmitting portions and a width of each of the second light shielding portions is 1:1.

23. The wavefront measuring apparatus according to claim 17, wherein the pitch P1 of the first grating fulfils the following expression provided that λ represents a wavelength of the illumination light and NAin represents a numerical aperture of the projection optical system on the side of the object plane:
4×λ/Nain≦P1≦200×λ/NAin.

24. The wavefront measuring apparatus according to claim 23, wherein the pitch P1 of the first grating fulfils the following expression:
8×λ/Nain≦P1≦100×λ/NAin.

25. The wavefront measuring apparatus according to claim 17, wherein the arithmetic section has a single image forming unit which performs a single image forming process for the intensity distribution of the interference fringes provided as the detection result of the photoelectric sensor.

26. The wavefront measuring apparatus according to claim 17, further comprising a liquid supply device which supplies a liquid to an optical path for the illumination light ranging from the projection optical system to the second grating and an optical path for the illumination light ranging from the second grating to a predetermined surface, the illumination light being transmitted through the liquid.

27. The wavefront measuring apparatus according to claim 17, wherein the illumination system illuminates the first grating with the illumination light having a coherence factor of 0.8 to 1.

28. An exposure apparatus which illuminates a pattern with an illumination light and exposes an object with the illumination light via the pattern, the exposure apparatus comprising:
a projection optical system which projects, onto the object, an image of the pattern illuminated with the illumination light; and
the wavefront measuring apparatus as defined in claim 17 which is used to determine the wavefront information of the projection optical system;
wherein the pattern is illuminated by using the illumination system of the wavefront measuring apparatus.

29. The exposure apparatus according to claim 28, further comprising a first stage which is movable while holding the object; wherein the second grating and the photoelectric sensor are provided on the first stage.

30. The exposure apparatus according to claim 28, further comprising a liquid supply device which supplies a liquid to an optical path for the illumination light ranging from the projection optical system to the second grating and an optical path for the illumination light ranging from the second grating to a predetermined surface, the illumination light being transmitted through the liquid.

31. The exposure apparatus according to claim 28, wherein light shielding portions and light transmitting portions are arranged alternately on the first grating while extending in a predetermined direction.

32. The exposure apparatus according to claim 28, wherein the first grating includes a pair of gratings in which light shielding portions and light transmitting portions are arranged alternately; the light shielding portions and the light transmitting portions of one grating, of the pair of gratings, extend in a predetermined direction; and the light shielding portions and the light transmitting portions of the other grating extend in a direction perpendicular to the predetermined direction.

33. The exposure apparatus according to claim 29, further comprising a second stage which is movable while holding the pattern;
wherein the pattern is illuminated with the illumination light to expose the object via the pattern and the projection optical system while synchronously moving, in a scanning direction, the pattern held by the second stage and the object held by the first stage during the exposure; and the wavefront measuring apparatus determines the wavefront information of the projection optical system while holding the first grating by the second stage and moving, in the scanning direction, the second grating provided on the first stage or the first grating held by the second stage during the measurement of the wavefront.

34. A device producing method comprising exposing a substrate by using the exposure method as defined in claim 13; and processing the exposed substrate.

35. A device producing method comprising exposing a substrate by using the exposure apparatus as defined in claim 28; and processing the exposed substrate.
